(19) United States
(12) Patent Application Publication
(10) Pub. No.: US 2024/0079885 A1
(43) Pub. Date: Mar. 7, 2024

(54) ELECTRONIC CIRCUIT FOR BATTERY PACK CONFIGURATION MANAGEMENT

(71) Applicant: Donald Siu, Santa Ana, CA (US)

(72) Inventor: Donald Siu, Santa Ana, CA (US)

(21) Appl. No.: 18/146,631

(22) Filed: Dec. 27, 2022

Related U.S. Application Data
(60) Provisional application No. 63/374,413, filed on Sep. 2, 2022.

(51) Int. Cl. H02J 7/00; H01M 10/42; H02J 7/34; H02J 9/00

(52) U.S. Cl. CPC H02J 7/0024; H01M 10/425; H02J 7/00304; H02J 7/00309; H02J 7/0036; H02J 7/0045; H02J 7/0047; H02J 7/0063; H02J 7/00712; H02J 7/345; H02J 9/00

(57) ABSTRACT

Methods, systems and apparatus for providing power from a battery pack are described. One example method of connecting batteries in a battery pack include providing a battery pack comprising multiple independent compartments where each compartment is configured to hold at least one battery that has no direct electrical contact with batteries in other compartments of the multiple compartments, detecting, upon a placement of batteries in the multiple compartments, occurrence of the placement, and operating an electronic circuit such that batteries in the multiple compartments are connected together according to a configuration irrespective of polarity orientations by which the batteries were placed in the compartments.

### CROSS-REFERENCE TO RELATED APPLICATION(S)

This patent document claims the priority and benefits of U.S. Patent Application No. 63/374,413, entitled “ELECTRONIC CIRCUIT FOR BATTERY PACK CONFIGURATION MANAGEMENT” and filed on Sep. 2, 2022, which is incorporated herein by reference in its entirety.

### TECHNICAL FIELD

The present document relates to electronic circuits, and in particular electronic circuits that control battery operation.

### BACKGROUND

Many electronic devices use power that is supplied from one or more batteries. As the number of consumer electronics and automotive products that use batteries increases, so is the demand on error-free and easy placement and removal of batteries from a battery pack.

### SUMMARY

This document discloses techniques for allowing a polarity-independent placement of batteries in a battery pack. An electronic circuits detects how each battery is placed and provides power according to a configuration that may be a series, a parallel or a series/parallel configuration.

In one example aspect a method of connecting batteries in a battery pack include providing a battery pack comprising multiple independent compartments where each compartment is configured to hold at least one battery that has no direct electrical contact with batteries in other compartments of the multiple compartments, detecting, upon a placement of batteries in the multiple compartments, occurrence of the placement, and operating an electronic circuit such that batteries in the multiple compartments are connected together according to a configuration irrespective of polarity orientations by which the batteries were placed in the compartments

In another aspect, an integrated circuit (IC) package is disclosed. The IC package includes one or more electronic circuits. The electronic circuits include multiple transistors electronically coupled to multiple independent compartments of a battery pack, wherein each compartment of the multiple independent compartments is configured to allow insertion of at least one battery with any polarity orientation, and wherein the batteries inserted in the multiple compartments are without a directly electrical contact with each other, wherein the electronic circuit is configured to operate to provide a voltage to a load by coupling the multiple batteries according to a configuration; wherein the electronic circuit is integrated into the IC package.

These, and other, features are described in this document.

### DESCRIPTION OF THE DRAWINGS

FIG. 1A depicts an example of Battery Polarity Detecting and Switching Using 2 N-Channel metal oxide semiconductor field effect transistors (MOSFETs) and 2 P-Channel MOSFETs.

FIG. 1B shows a same detects a circuit example similar to FIG. 1A, with added PTC For Current Limiting Protection.

FIG. 2 shows an example of an Equivalent Circuit Showing Q2, Q4 ON and Q1, Q3 OFF. Here, Notes: arrowed lines 200 show the current flowing through the load with Q2 and Q4 turned on.

FIG. 3 shows an example in which Q2, Q4 OFF and Q1, Q3 ON, With Battery Polarity In Reverse While The Load Polarity Remained Unchanged.

FIG. 4 is an example of a circuit implementing Battery Polarity Detecting and Switching Using 4 N-Channel MOSFETs, Connected As Diodes.

FIG. 5 shows Equivalent Circuit Showing Q1, Q3 ON and Q2, Q4 OFF

FIG. 6 is an example of a circuit implementing Q1, Q3 OFF and Q2, Q4 ON, With Battery Polarity In Reverse.

FIG. 7 is an example of a circuit implementing Detecting, Switching and Connecting 4 Battery Cells in Series, Using 8 N-Channel MOSFETs and 8 P-Channel MOSFETs.

FIG. 8 shows an example of an Equivalent Circuit of Detecting, Switching and Connecting 4 Battery Cells in Series, Using 8 N-Channel MOSFETs and 8 P-Channel MOSFETs.

FIG. 9 is an example of a circuit implementing Detecting, Switching and Connecting 4 Battery Cells in Series, With 16 MOSFETs Connected As Diodes.

FIG. 10 shows an example of an Equivalent Circuit of Detecting, Switching and Connecting 4 Battery Cells in Series, With 16 MOSFETs Connected As Diodes.

Here, arrows 1000 show the current flowing from the positive terminal of battery B1 through the load, into the negative terminal of battery B4, then continued by arrows 1002 which show the current flowing through the series connected batteries B4, B3, B2 and finally completes the series circuit at the negative terminal B1.

Battery internal arrows show the battery internal currents as they discharge.

For simplicity, the transistor on-channel voltages are not shown in the VOUT equation.

FIG. 11 is an example of a circuit implementing Detecting, Switching and Connecting 4 Battery Cells in Parallel, Using 8 N-Channel MOSFETs and 8 P-Channel MOSFETs.

FIG. 12 shows an example of Equivalent Circuit of Detecting, Switching and Connecting 4 Battery Cells in Parallel, Using 8 N-Channel MOSFETs and 8 P-Channel MOSFETs.

FIG. 13 is an example of a circuit implementing Detecting, Switching and Connecting 2 Sets of Battery Cells in Parallel With Each Set Consisting of 2 Cells in Series. The Circuit Uses 8 N-Channel MOSFETs and 8 P-Channel MOSFETs.

Note: With 4 batteries in series and parallel combination, there are a total of 16 combinations that these 4 batteries can be connected. The polarity of the output voltage, however remained unchanged irrespective of the 16 combinations that these 4 batteries are connected.

FIG. 14 is an example of Equivalent Circuit of Detecting, Switching and Connecting 4 Battery Cells in Series and Parallel Combination, Using 8 N-Channel MOSFETs and 8 P-Channel MOSFETs. Here, arrows 1400 show the current flowing from the positive terminal of each respective set of series-connected batteries through the load, and returns to the negative terminal of each respective set of series-connected batteries as shown by arrows 1402. IOUT shows the total parallel current of two series-connected batteries. Battery internal arrows show the battery internal currents as they discharge. Dash lines indicate the transistor gate controls. For simplicity, the transistor on-channel voltages are not shown in the VOUT equation.

FIG. 15 shows an example embodiment of a battery pack, with 4 cells in series, in parallel or in series/parallel, has 16 combinations of connection. This embodiments allows all 16 combinations to output the correct voltage and polarity.

FIG. 16 shows an example embodiment of a 3.7V Li-ion Rechargeable Battery Polarity Detecting and Switching in a Charging Mode.

FIG. 17 shows an Equivalent Circuit Showing Q2, Q4 ON and Q1, Q3 OFF in a Charging Mode. With switch S selected for charging, arrows 1700 show the power supply current flowing from the positive terminal through the switch S, Q2 and into the battery positive terminal. The return current path of the power supply as shown by gray arrows, from the battery negative terminal through Q4 and into the negative terminal of the power supply. The power supply voltage=4.2V+Von, Where Von=Q2 on-channel voltage+Q4 on-channel voltage

FIG. 18 shows an example embodiment in Charging Mode—Detecting, Switching and Connecting 4 Series Batteries.

FIG. 19 shows an example of the Equivalent Circuit of FIG. 7 In Charging Mode. With switch S selected for charging, arrows 1900 show the power supply current flowing from the positive terminal through the switch S, and through the respective transistors and batteries. The return current path of the power supply as shown by arrows 1902, from the B4 battery negative terminal and into the negative terminal of the power supply. The power supply voltage=4Vcharge+4Von, Where Von=the sum of 2 on-channel voltages.

FIG. 20 shows an example of an Integrated Circuit Design.

FIG. 21 is an example of a circuit for Detecting, Switching and Connecting 4 Battery Cells in Series, Using 8 N-Channel MOSFETs and 8 P-Channel MOSFETs.

FIG. 22 shows an example embodiment of a 4-cell configuration.

FIG. 23 shows an example of an implementation of low power detection.

FIGS. 24 and 25 are flowcharts of an example methods.

### DETAILED DESCRIPTION

Section headings are used in the present document, including the appendices, to improve readability of the description and do not in any way limit the discussion to the respective sections only.

The polarity detecting and switching of a battery typically requires 4 MOSFETs, connected as transistors or as diodes. When a low voltage battery, such as 1.5V AA or AAA size, is used. Due to high forward-diode voltage drop of 0.3V or higher, it is not practical to use diodes, but it is more practical to use MOSFETs transistors with gate control. When the gate-to-source threshold voltage Vgs is reached, typically from 0.6V to 1.2V, depending on the polarity of the battery, the respective pair of N-channel and P-channel MOSFETs are turned on, connecting the drain to the source, establishing a low on-channel resistance and low on-channel voltage drop. At the same time, the other pair of N-channel and P-channel MOSFETs are turned off. In using 1.5V battery, the MOSFET is selected for low drain-source on-resistance.

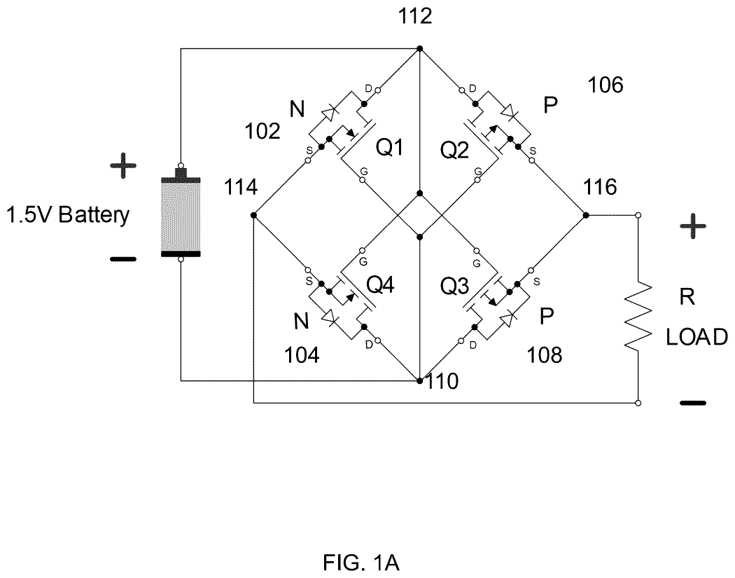

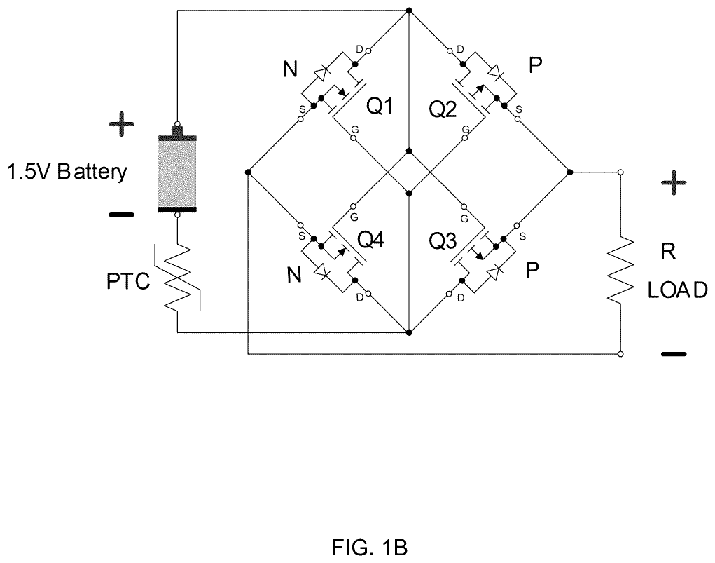

FIG. 1A shows 4 MOSFETs, 2 N-channel type and 2 P-channel type, connected to a 1.5V battery. As further explained herein, this circuit can be used to detect battery polarity and switching.

FIG. 1B Same detects a circuit example similar to FIG. 1A, with added PTC (positive temperature coefficient) for Current Limiting Protection.

In FIGS. 1A-1B, Q1 to Q4 represent MOSFETs and R represents load of the appliance being powered by the battery. In the configuration shown in FIGS. 1A-1B, four transistors are connected in a circuit in which gates of a first N MOSFET 102 and a first P MOSFET 106 are electrically connected to each other, and connected to a node 110 that is coupled to the negative end of the battery configuration that contains one or more cells. The drain terminals of a second N MOSFET 104 and a second P MOSFET 108 are also electrically coupled to the node 110. Drains of the first N MOSFET 102 and the first P MOSFET 106 are electrically coupled to a second node 112 that is electrically coupled to the positive end of the battery configuration.

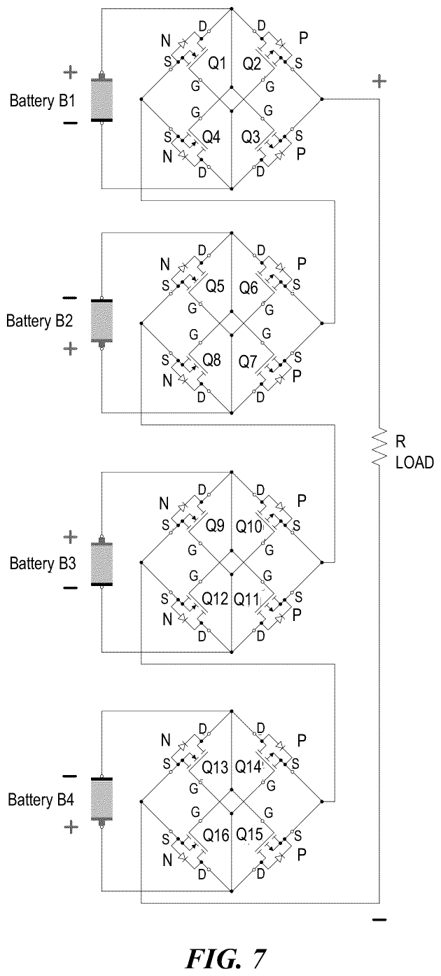

In the circuit depicted in FIGS. 1A-1B, the power provided to the load is provided across a third node 116 (positive voltage side) that is electrically coupled to sources of the P MOSFET 106 and the P MOSFET 108. The negative terminal of the load is electrically coupled to the fourth node 114 that is electrically coupled to the source terminals of the N MOSFET 102 and the N MOSFET 104. As a result of the MOSFET structure, the body diode is formed by the PN junction between the source and drain, and is also called an internal diode. It is noted that this circuit arrangement, is used in several additional embodiments described throughout the present document (e.g., FIGS. 7, 8, 11-14, 16-22).

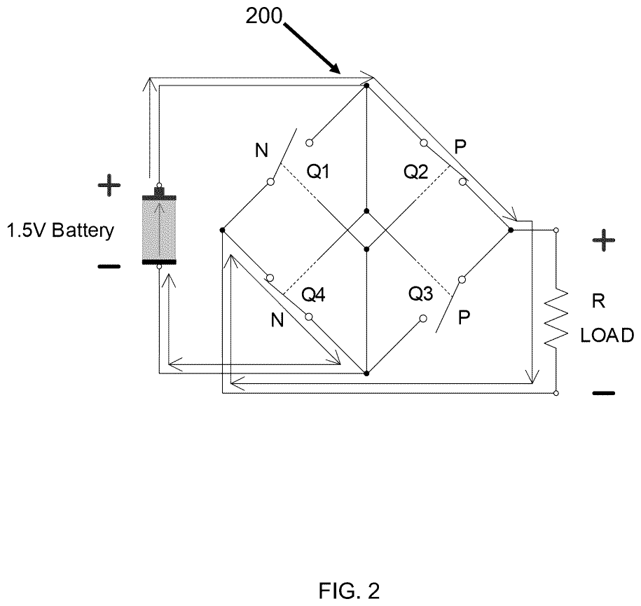

FIG. 2 shows the equivalent circuit of the circuit configuration of FIGS. 1A-1B. With the battery as connected, Q2 and Q4 are turned on (while Q1 and Q3 are off), allowing the current to flow from the battery positive terminal through the load, and returning to the battery negative terminal. Arrow internal to the battery shows the battery internal current as it discharges. In FIG. 2, dash lines indicate the transistor gate controls.

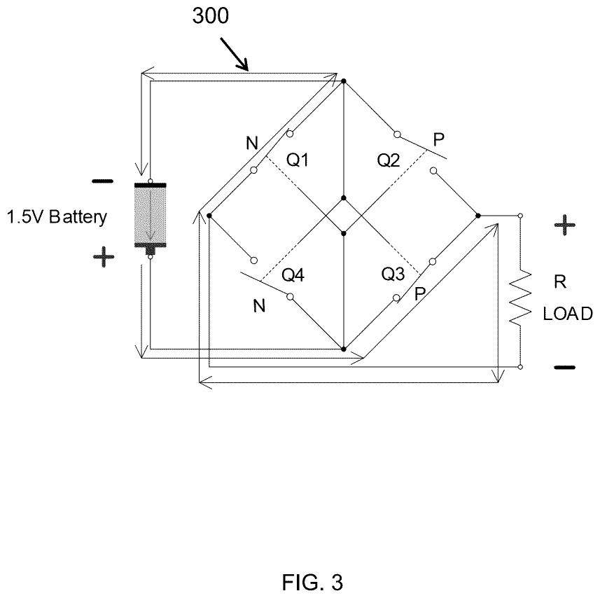

In FIG. 3, with the battery polarity in reverse, Q1 and Q3 are turned on (while Q2 and Q4 are off), notice that this time the current takes a different path from the battery positive terminal through the load, and returning to the battery negative terminal. Meanwhile, the load polarity remained unchanged through both configurations of FIGS. 2 and 3. Here, arrows 300 show the current flowing through the load with Q1 and Q3 turned on. Arrow inside battery shows the battery internal current as it discharges and dash lines indicate the transistor gate controls.

For applications where the battery voltage, 3.7V, 9V, 12V or greater, is relatively higher than the forward-diode voltage drop, a simpler configuration in which diodes or MOSFETs connected as diodes can be used.

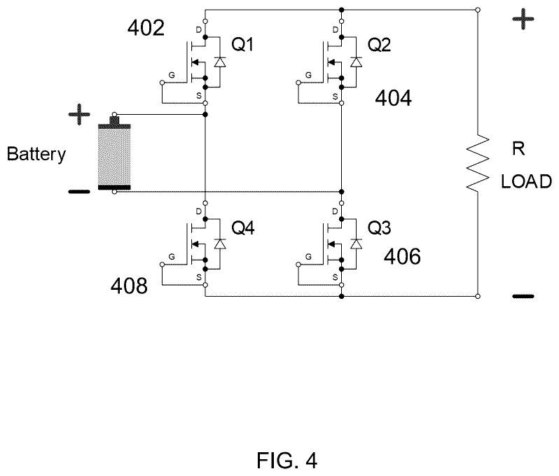

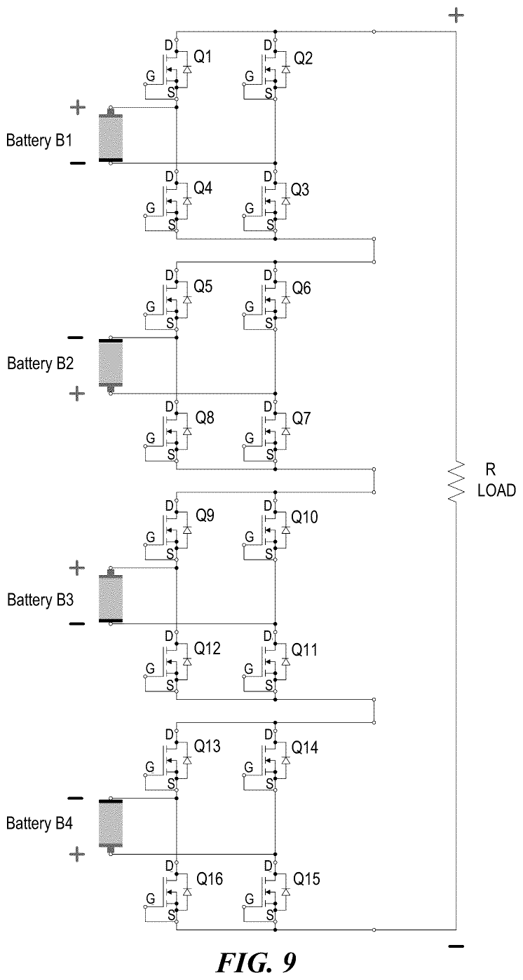

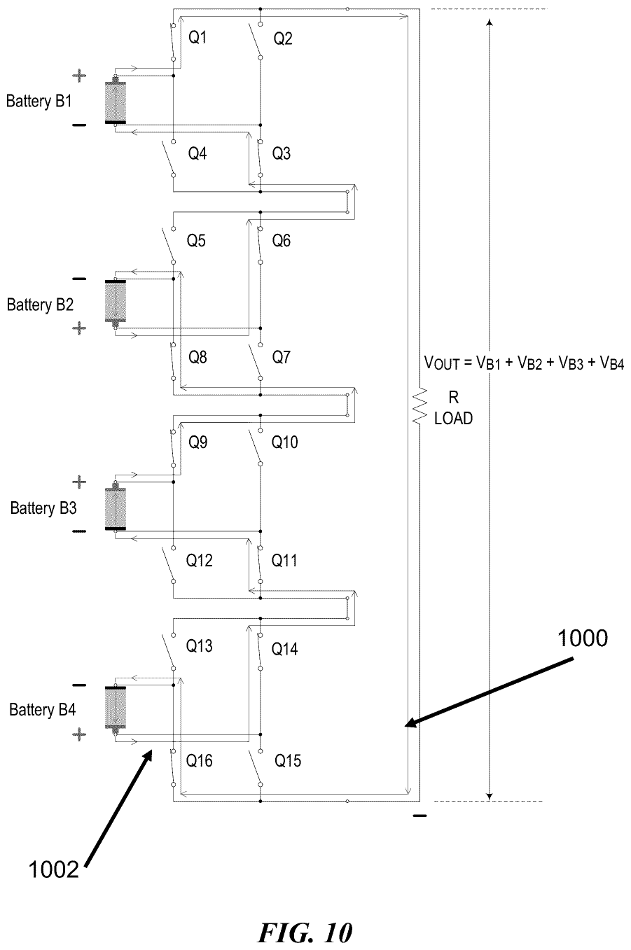

FIG. 4 shows 4 N-channel MOSFETs, connected as diodes, with a battery at the input. In the depicted circuit configuration, drains of MOSFETS 402, 404 are electrically coupled with positive terminal of the load. Source terminals of MOSFETS 406, 408 are coupled with the negative end of the load. The negative terminal of the battery is electrically coupled to the drain of transistor 406 and to the source of transistor of 404. Source terminal of transistor 402 is coupled to the drain of transistor 408 and source of transistor 404 is coupled to drain of transistors 406. The gate and source terminal of each transistor is electrically coupled together. The transistor configuration of FIG. 4 is used in several other embodiments disclosed in the present document, e.g., with respect to FIGS. 9-10.

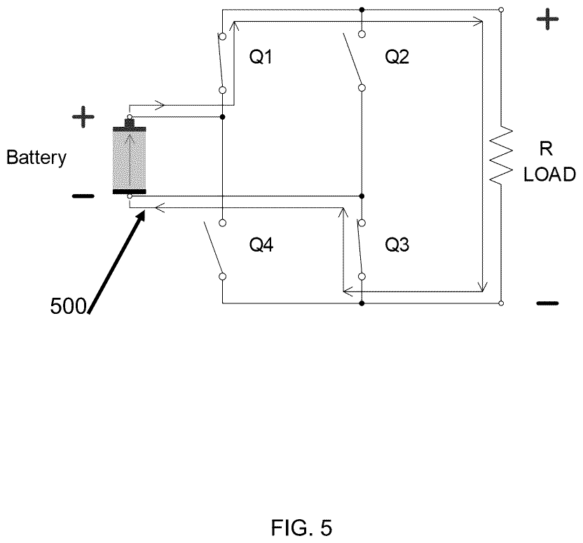

FIG. 5 shows the equivalent circuit of FIG. 4. With the battery as connected, Q1 and Q3 are turned on (while Q2 and Q4 are off), allowing the current to flow from the battery positive terminal through the load, and returning to the battery negative terminal. Arrows 500 show the current flowing through the load with Q1 and Q3 turned on. Battery internal arrow shows the battery internal current as it discharges.

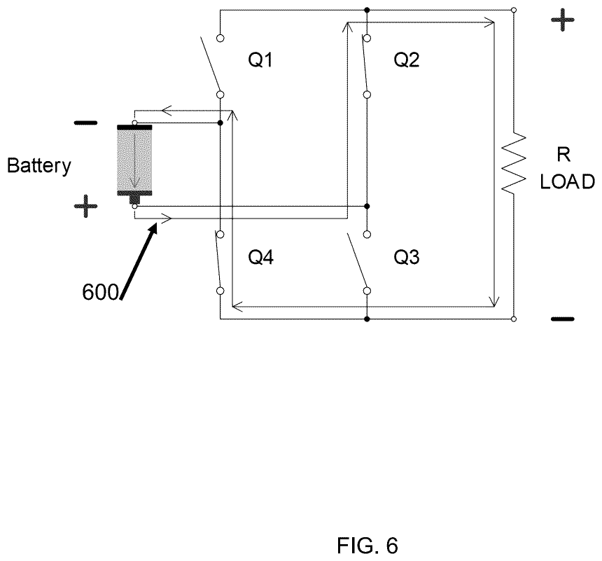

In FIG. 6, with the battery polarity in reverse, Q2 and Q4 are turned on (while Q1 and Q3 are off), notice that this time the current takes a different path from the battery positive terminal through the load, and returning to the battery negative terminal. Meanwhile, the load polarity remained unchanged through both configurations of FIGS. 5 and 6. In FIG. 6, load polarity remained unchanged. Arrows 600 show the current flowing through the load with Q2 and Q4 turned on. Internal arrows of the batteries show the currents internal to the batteries.

A conventional 4-cells battery pack has 4 series-connected cells in a single column, 4 series-connected cells in 2 columns, or 4 series-connected cells in 4 columns. Each battery directly connects to the next battery in series.

The 4-cells battery pack described herein requires that each of the 4 cells has its own compartment. None of the 4 cells is allowed to have direct connection with the adjacent cell. Each cell's polarity is independently detected, switched by 4 transistors, and finally interconnected with other cells to deliver the output voltage equal to the sum of 4 battery voltages in series minus 2 voltage drops across 2 transistors for each battery.

The bipolar transistor is a current-controlled transistor, whereas the MOSFET is a voltage-controlled transistor. Unlike bipolar transistor which requires a small but sufficient current flowing through the base-emitter junction before the collector-emitter channel can be turned on that allows a larger current to flow through the channel. The MOSFET, however, requires a proper charge voltage at the gate to turn on one polarity of MOSFET, while at the same time to turn off the opposite polarity of the MOSFET. For the N-channel MOSFET to turn on, the gate voltage must be more positive than the source. For the P-channel MOSFET to turn on, the gate voltage must be less positive than the source. Because of this characteristic, only a charge voltage is required at the gate to turn on/off the MOSFETs, the battery pack described herein, without a load connected to its output, draws zero current.

Throughout this disclosure, the term battery pack is used for the description. Although other names such as battery holder, battery case or battery compartment, all have the equivalent meaning.

MOSFET technology has been improved significantly during the past several years. Low on-channel voltage drop and low on-channel resistance, required by this application, are trending lower in recent years, thus making this practical application a reality.

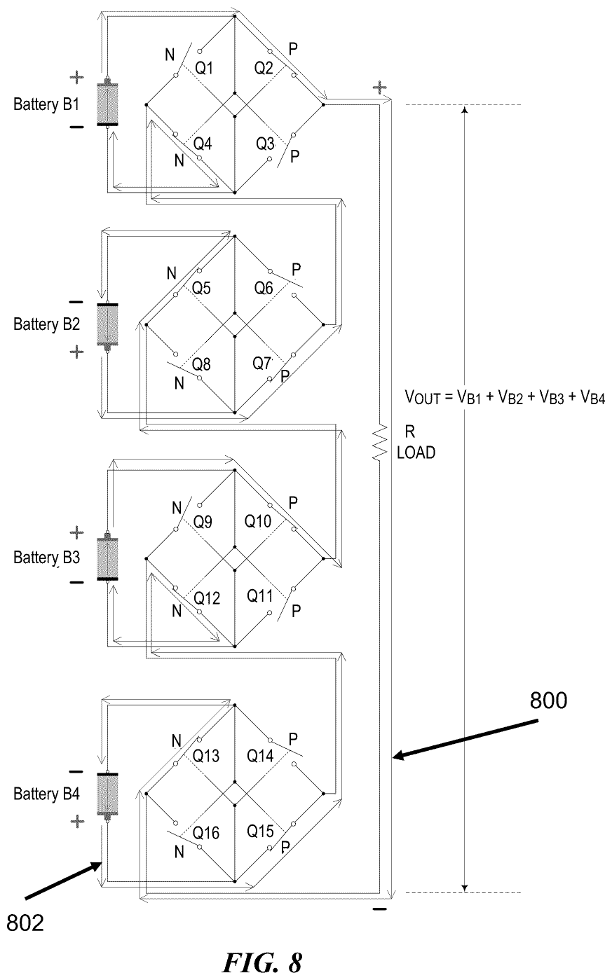

A 4-batteries in series configuration is shown in FIG. 7, and its equivalent circuit is shown in FIG. 8. Here, 8 N-channel MOSFETS and 8 P-channel MOSFETs are used. With 4 batteries in series, there are a total of 16 possible combinations that these 4 batteries can be connected. The polarity of the output voltage, however remained unchanged irrespective of the 16 combinations that these 4 batteries are connected.

Arrows 800 show the current flowing from the positive terminal of battery B1 through the load, into the negative terminal of battery B4, then continued by arrows 802 which show the current flowing through the series connected batteries B4, B3, B2 and finally completes the series circuit at the negative terminal B1. Internal battery arrows show the battery internal currents as they discharge. Dash lines indicate the transistor gate controls. For simplicity, the transistor on-channel voltages are not shown in the VOUT equation.

A 4-batteries in series configuration is shown in FIG. 9 with MOSFETs connected as diodes, and its equivalent circuit is shown in FIG. 10. With 4 batteries in series, there are a total of 16 possible combinations that these 4 batteries can be connected. The polarity of the output voltage, however remained unchanged irrespective of the 16 combinations that these 4 batteries are connected.

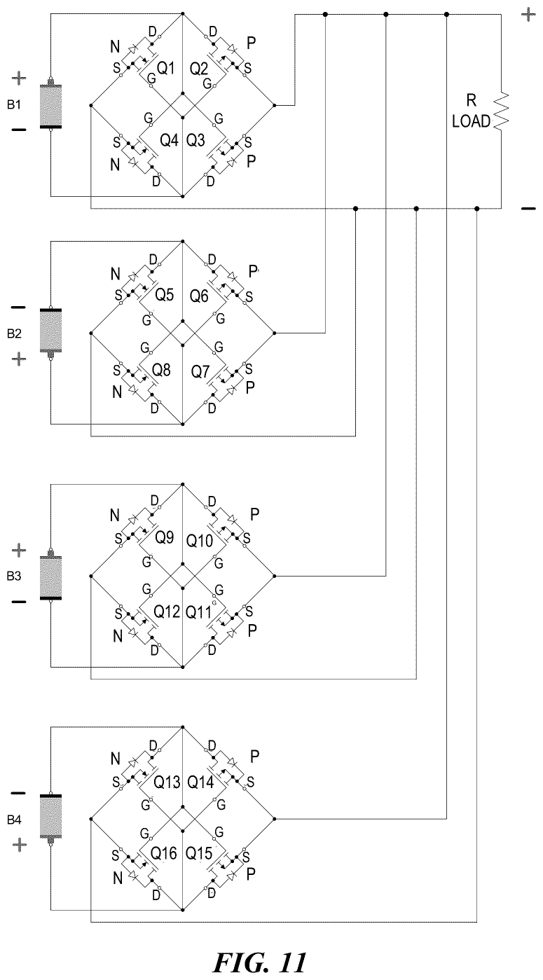

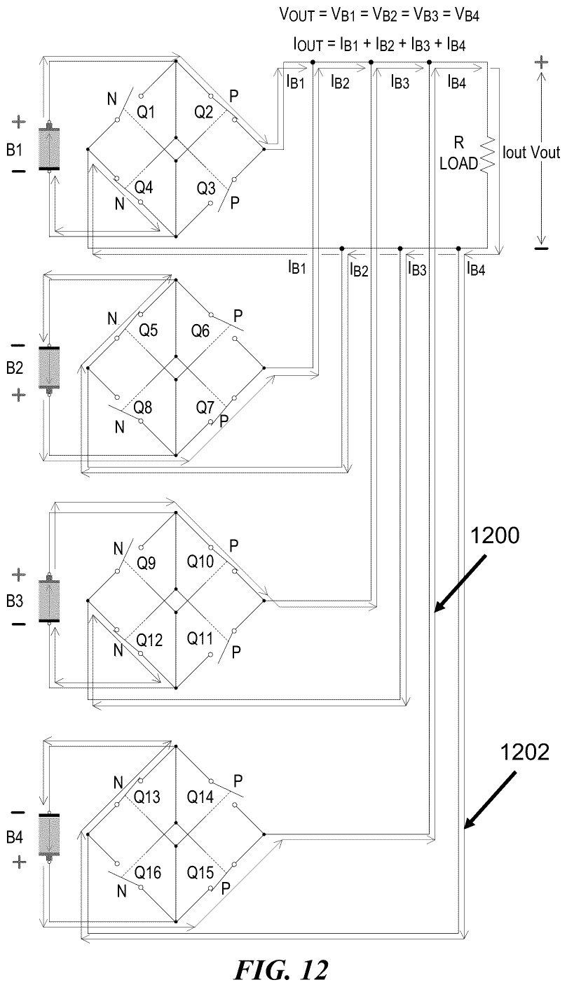

A 4-batteries in parallel configuration is shown in FIG. 11, and its equivalent circuit is shown in FIG. 12. Note: With 4 batteries in parallel, there are a total of 16 possible combinations that these 4 batteries can be connected. The polarity of the output voltage, however remained unchanged irrespective of the 16 combinations that these 4 batteries are connected. Arrows 1200 show the current flowing from the positive terminals of batteries B1, B2, B3, B4 through the load, and returning to their respective negative terminals as shown by arrows 1202. Battery internal arrows show the battery internal currents as they discharge. Dash lines indicate the transistor gate controls. For simplicity, the transistor on-channel voltages are not shown in the VOUT equation.

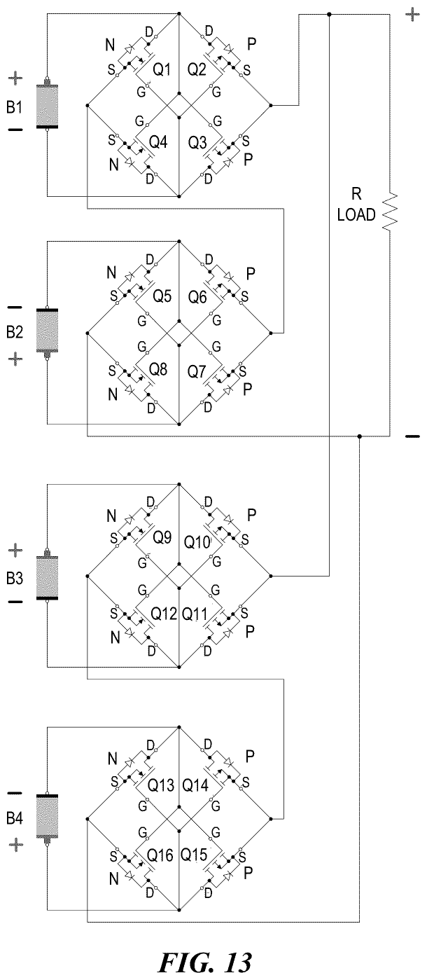

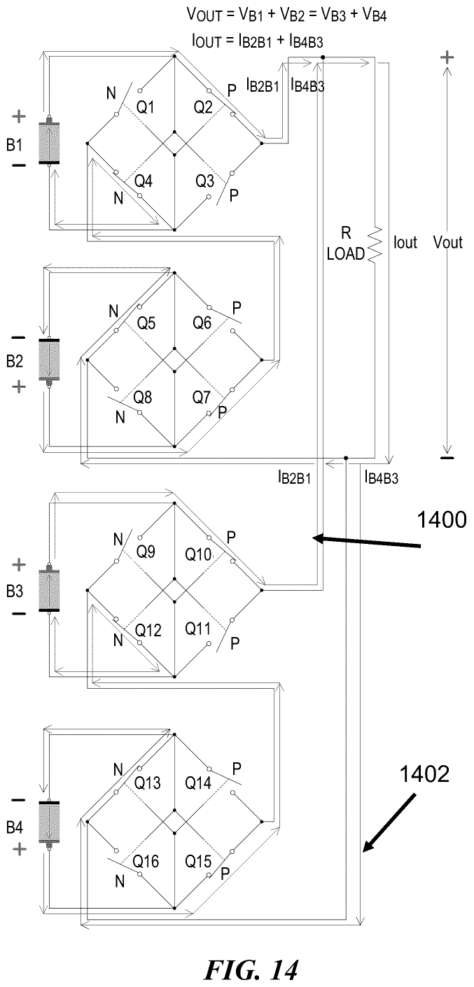

A 4-batteries in series/parallel configuration is shown in FIG. 13, and its equivalent circuit is shown in FIG. 14.

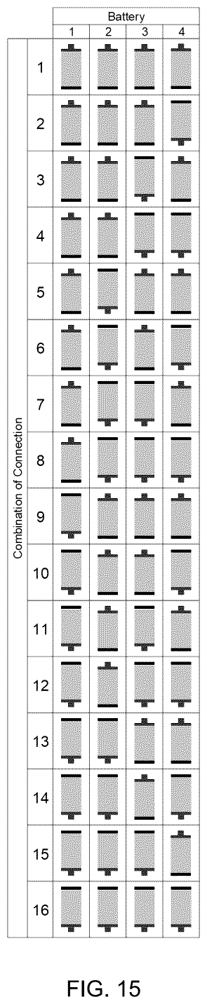

FIG. 15 shows all possible battery connections using 4 batteries in series.

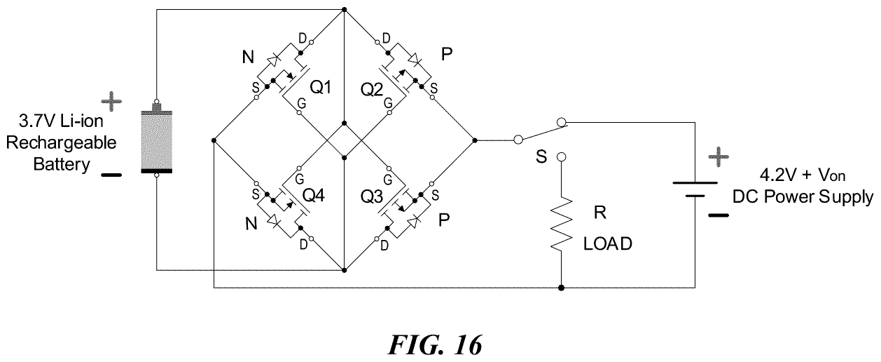

The foregoing descriptions and figures (FIGS. 1 through 14) are all applicable to disposable batteries. However, only the descriptions associated with figures (FIGS. 1, 2, 3, 7, 8, 11, 12, 13, 14, 16, 17, 18 and 19) are applicable to both disposable and rechargeable batteries. In other words, the rechargeable batteries do not work in FIGS. 4, 5, 6, 9 and 10 where MOSFETs are connected as diodes, only the disposable batteries work. This is because in the diode configuration, the gate and source are shorted together, which allows the battery current to flow in one way only. Whereas, in the transistor configuration, the battery current can flow out to the load in the discharging mode, and the power supply current can flow back into the battery in the charging mode (Ref. FIGS. 16, 17, 18 and 19). The requirement in the charging mode is that each depleted battery must have a voltage equal to the minimum Vgs threshold that keeps the drain-to-source channel on to allow the charging current to flow into the battery.

FIG. 16: 3.7V Li-ion Rechargeable Battery Polarity Detecting and Switching in a Charging Mode.

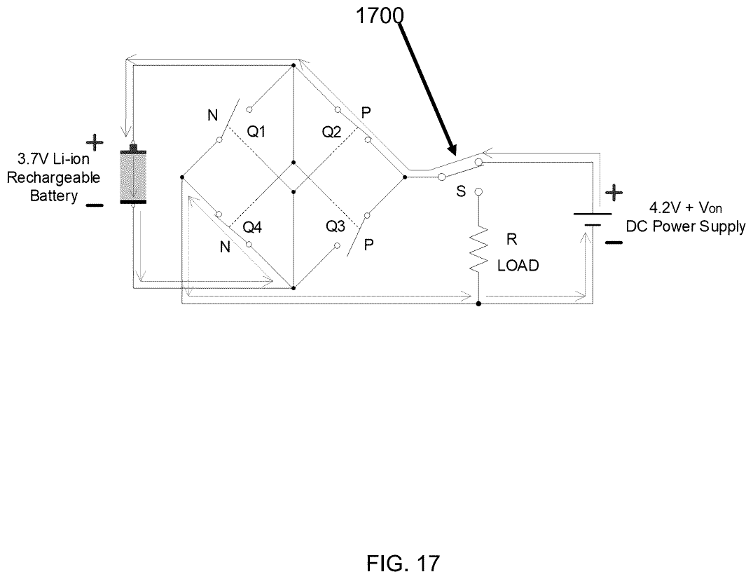

FIG. 17: Equivalent Circuit Showing Q2, Q4 ON and Q1, Q3 OFF in a Charging Mode.

Notes: With switch S selected for charging, arrows 1700 show the power supply current flowing from the positive terminal through the switch S, Q2 and into the battery positive terminal.

The return current path of the power supply as shown by gray arrows, from the battery negative terminal through Q4 and into the negative terminal of the power supply.

The power supply voltage=4.2V+Von, Where Von=Q2 on-channel voltage+Q4 on-channel voltage

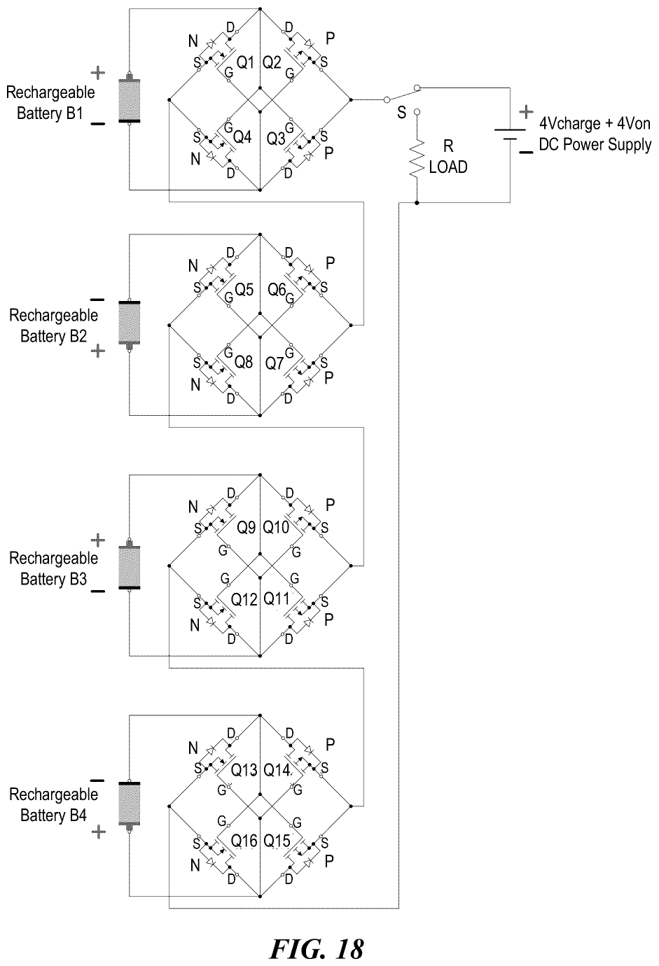

FIG. 18: In Charging Mode—Detecting, Switching and Connecting 4 Series Batteries.

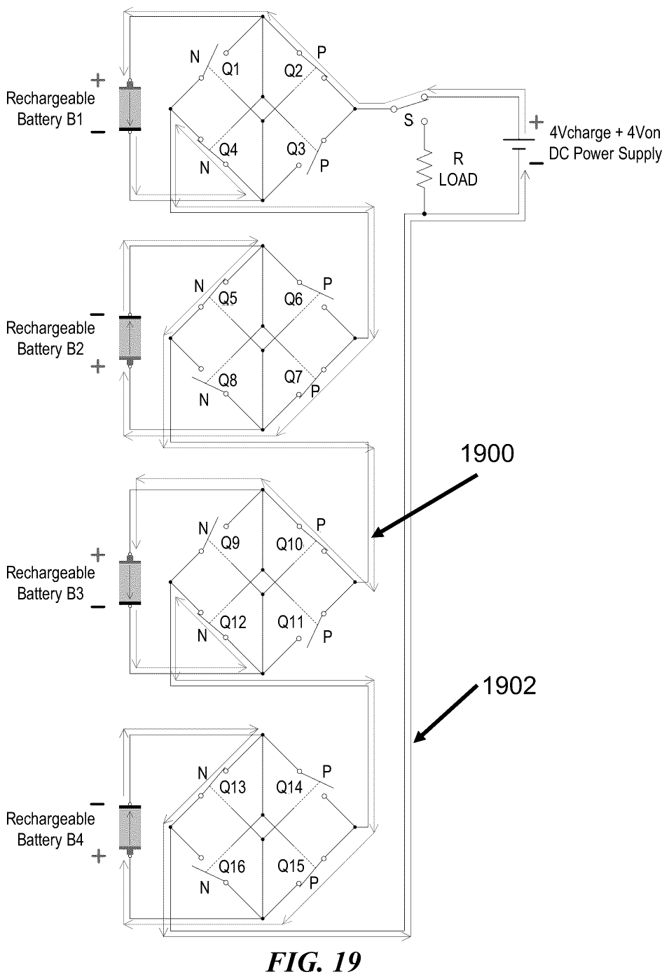

FIG. 19: The Equivalent Circuit of FIG. 7 In Charging Mode.

Notes: With switch S selected for charging, arrows 1900 show the power supply current flowing from the positive terminal through the switch S, and through the respective transistors and batteries.

The return current path of the power supply as shown by gray arrows, from the B4 battery negative terminal and into the negative terminal of the power supply.

The power supply voltage=4Vcharge+4Von, Where Von=the sum of 2 on-channel voltages

In the rechargeable battery configurations, the load is replaced by the DC power supply which has voltage higher than that of the total battery voltage in the configuration, plus additional voltage as required by different battery chemical compositions, to force the current to flow into the batteries, but not too much higher or the batteries may be damaged. In the recharging mode, It is required that the rechargeable battery must have a remaining charged voltage equal or greater than the Vgs threshold voltage for the MOSFETs to maintain the auto-polarity, which establish the connecting paths for the DC supply current to flow into the batteries. As shown in FIGS. 16 and 17, the 3.7V Li-ion battery requires a charging voltage of 4.2V plus 2 on-channel voltage drops. The switch S is a mechanical switch, an electro-mechanical switch (relay) or an electronic switch controlled by the computer. FIGS. 18 and 19 show 4 series-connected rechargeable batteries in a charging mode. The switch can be replaced by a load sharing charging circuit, in which the electronic switch, upon detecting the presence of the power supply, disconnects the load from the battery, and connects it to the power supply. At the same time, while not supplying power to the load, the battery connects to the power supply to receive a charge. When the power supply is absent, the electronic switch disconnects the load from the power supply, and connects it to the battery.

Safety feature can be added by connecting, in series to each battery (Ref. FIG. 1B), a Positive Temperature Coefficient (PTC) device or thermistor which, at room temperature, has low resistance through a range of currents. As excessive current flowing through the battery, the PTC is activated by self-heating, increasing its resistance, thus limiting the current. In this application, a PTC is used as a resettable fuse.

A common safety hazard in lithium ion battery pack is fire caused by thermal runaway. An over-temperature shutdown circuit can be implemented to detect an over temperature event, disconnecting the load before the thermal runaway is initiated.

New names are needed to distinguish this new battery pack from a conventional one. It will be called Smart-Battery-Pack, Auto-Polarity-Battery-Pack, Any-Way-Battery-Pack or No-Look-Battery-Pack.

Applications: There are a number of ways that this solution can be used. Below are some typical applications.

The 16 MOSFETs, 8 N-channel and 8 P-channel, required for the automatic detecting, switching and connecting 4 batteries, can be integrated in one integrated circuit, which can be mass produced, offering a compact and low cost solution.

A new battery pack, either disposable or rechargeable, in which each cell has its own compartment. Each cell's polarity is independently detected, switched and interconnected to other cells to deliver the output voltage as determined by one of three configurations that is in series, in parallel or in series/parallel combination.

Portable devices and equipment can be upgraded that will have this solution built-in.

Portable device using a single cell or multiple cells can quickly has its batteries replaced without requiring the user to observe and to follow the polarity markings.

Since the battery polarity observation and handling is no longer an issue. It is possible to make a battery with uniform appearance. For ease of manufacturing, both positive and negative terminals can be made to look the same.

Electric vehicle (EV), depending on capacity, can have thousands of 3.7V lithium ion batteries connected in series/parallel combination to deliver several hundred volts of output DC voltage that drives the electric motors. The solution can be used as an added layer of protection for automatic polarity correction.

In the battle field, a soldier can replace the batteries in the dark. Because turning on the flash light to observe the battery polarity can give away his position to the enemy.

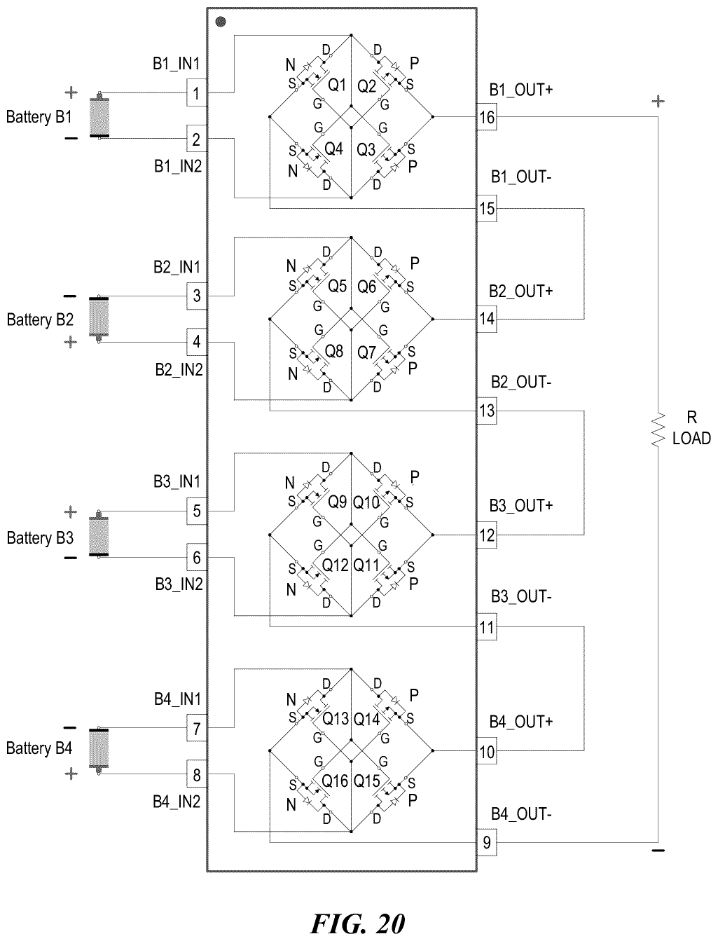

FIG. 20 shows an integrated circuit package, from which any one of 3 configurations can be accomplished by simply making the proper external connections.

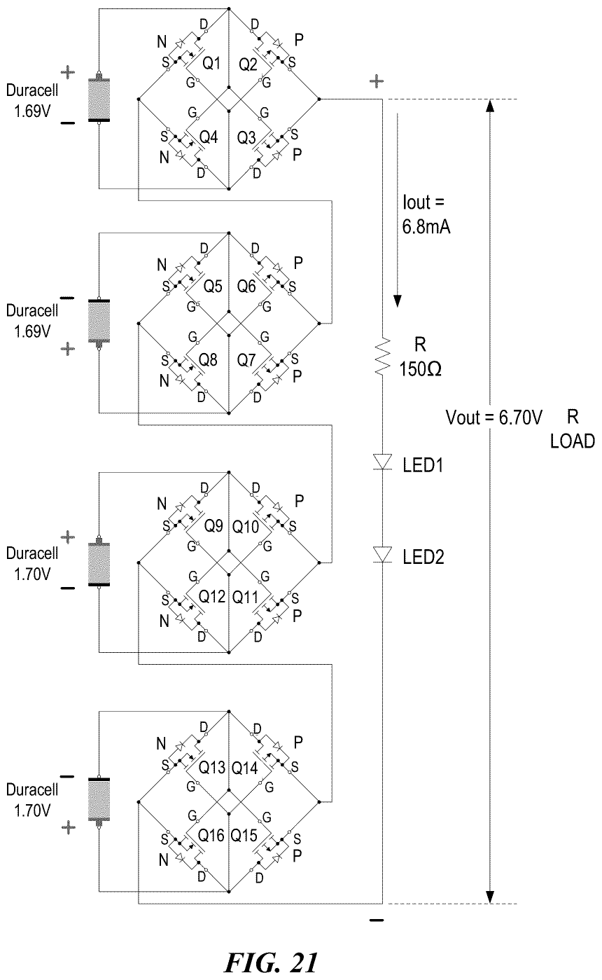

FIG. 21 shows an example circuit used for detecting, switching and connecting 4 battery cells in series, Using 8 N-Channel MOSFETs and 8 P-Channel MOSFETs.

With 4 batteries in series, there are a total of 16 possible combinations that these 4 batteries can be connected. The polarity of the output voltage, however remained unchanged irrespective of the 16 combinations that these 4 batteries are connected

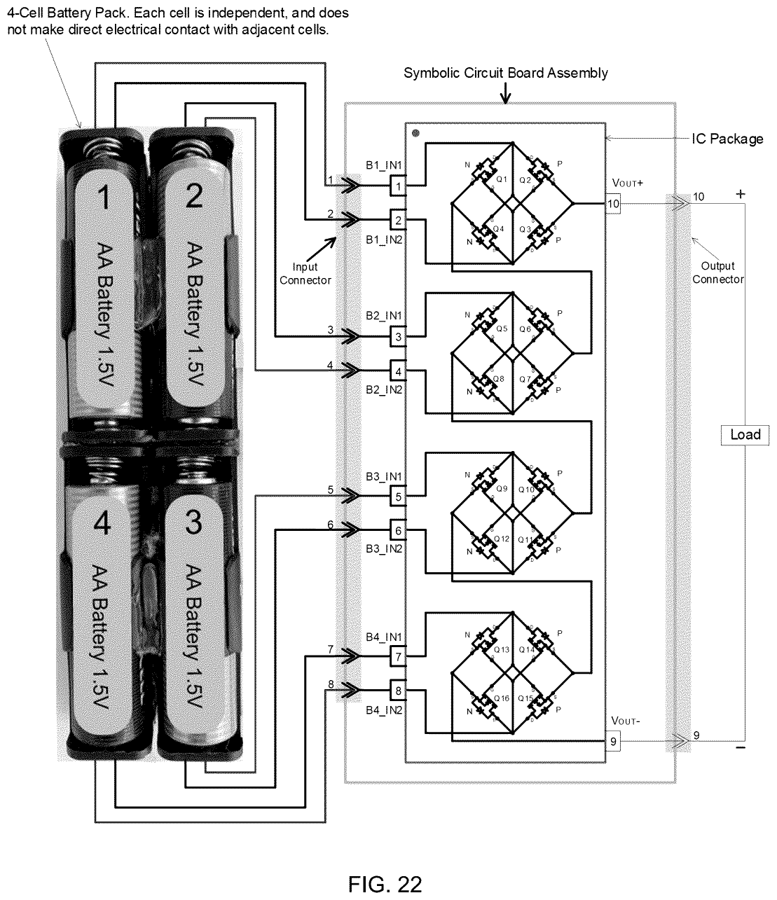

FIG. 22 shows the complete assembly of Auto-Polarity Battery Pack with 4 cells in series. The four battery cells are shown at the bottom of the drawing in a traditional vertical dual stack. However, it will be appreciated by a person of skill in the art that, in general, any way of arranging the cells may be used such as side-by-side or linear packing. Each cell in the packing is electrically isolated from the other cell without making direct electrical contact with neighboring cells. The anode and cathode leads of each cell are shown to be electrically coupled to a respective polarity circuit. These are numbered as lines 1 to 8. The circuits may be implemented in an IC package. The IC package may be mounted on a circuit card. Outputs of the IC package, numbered as 10 for positive voltage output and 9 for negative voltage output are used for operating an external load during use. Such a load may include an electrical appliance such as a flashlight bulb, a wireless charger, a radio, and so on.

In one beneficial aspect, the disclosed circuits may also be used to prolong the useful life of a battery cell. In another beneficial aspect, the disclosed circuits may be used to reduce wastefulness of battery replacement operation. For example, often, a user discards multiple battery cells from an appliance when battery runs low. The user typically has no way of finding out which of the multiple batteries is to be discarded and ends up throwing all batteries out, which is a waste of resources and an unnecessary creation of toxic waste. Using the techniques described in the present document, appliances are able to pinpoint to the user which battery cell(s) need replacement. Such a technique will result in selective battery replacement, which is a good benefit for environment and also for economic operation of the battery-powered equipment.

Normally, when a 1.5V battery, after a period of use, is considered depleted and discarded when its voltage drops down to 1.2V or down by 20%. Often, electronic devices stop working when battery voltage level falls below a certain threshold. For example, in such cases, the current drawn by the appliance falls below a current threshold that results in a total power supplied to the appliance below its operational requirement.

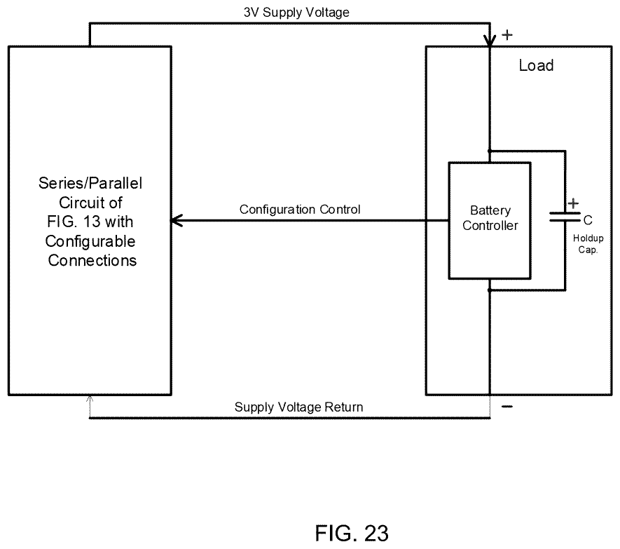

FIG. 23 shows an example scenario in which a load is connected to the auto-polarity battery pack of FIG. 13 with internal configurable connections. The load is equipped with an internal battery controller and a capacitor C, used as a power supply holdup storage. When the 3V supply voltage is discharged to 20% below the nominal 3V or 2.4V (or another suitable threshold that may be specific to the load), below which the load may stop working. The load's internal battery controller, upon detecting the 2.41V (0.01V or higher above the threshold of 2.4V if required) sends a command signal to the auto-polarity circuit to disconnect both batteries B3 and B4 from the series/parallel configuration, connect B3 in series with B2 and B1, and leave B4 unconnected. This automatically changes the battery configuration from series/parallel to series configuration on-the-fly and in real-time, while the load is operating, and without user intervention.

While the reconfiguration is in progress, the load may be momentarily disconnected from the battery pack, and is concurrently kept operational by the charge held by C. The C capacitance is selected to hold the 2.4V threshold long enough to allow for the complete battery reconfiguration. For example, the Vishay MOSFETs Si2302CDS (N-channel) and Si2301CDS (P-channel), each takes typically 50 nanoseconds to complete the switching.

With 3 batteries B1, B2 and B3 in series, at 1.2V each, the reconfiguration yields 3.6V. The load, experiences no loss of supply voltage, continues to operate until the next 2.4V threshold is reached, which may, for example, mean that each of the 3 batteries is now down to 0.8V. This time the battery controller sends command to connect battery B4, which is at 1.2V, in series with B1, B2 and B3. The reconfiguration yields 3.6V, which allows continuous operation for the load through both low voltage events. At some point after additional use, all 4 batteries may drop below 0.6V, or the total series voltage of 4 batteries drops below 2.4V.

All 4 batteries are finally discarded at 0.6V each, as opposed to 1.2V, which means in a conventional design, the battery is used for only 20% of its capacity, whereas in this application, the battery is used for up to 60% of its capacity, 3 times better in battery usage, or 200% increase in battery voltage depletion.

In an example embodiment, a maximum voltage that the load can sustain may be 4V. Upon detecting the upper threshold of 4V, due to one or more new installed batteries, the controller may send a command to change the configuration from series to series/parallel or 3V.

It will be appreciated that the above-described operation of circuits allows cost saving by extracting more usage from the batteries and is environmental friendly by reducing waste.

The following technical solutions are implemented by some preferred embodiments.

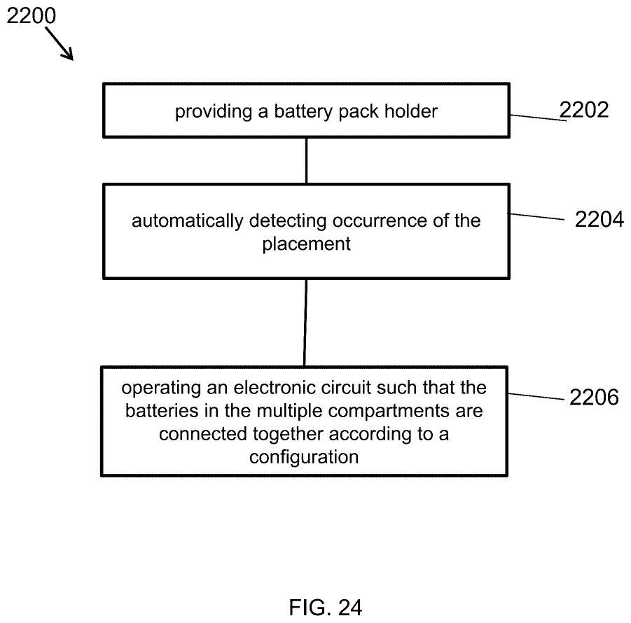

1. A method of connecting batteries in a battery pack (e.g., method 2200 depicted in FIG. 24), comprising: providing (2202) a battery pack holder comprising multiple independent compartments, wherein each compartment is configured to hold at least one battery that has no direct electrical contact with batteries in other compartments of the multiple compartments; automatically detecting (2204), upon a placement of batteries in the multiple compartments, occurrence of the placement, and operating an electronic circuit (2206) such that the batteries in the multiple compartments are connected together according to a configuration irrespective of polarity orientations of the placement of batteries.

2. The method of solution 1, wherein a load connected to the battery pack receives a same voltage and a same polarity irrespective of the compartmented battery polarity orientations.

3. The method of solution 1-2, wherein the batteries are of the same physical form and size.

4. The method of solution 1-2, wherein the batteries are a mixture of the different physical form and size.

5. The method of solution 1-4, wherein the electronic circuit comprises a network of 4 metal-oxide-semiconductor-field-effect-transistors (MOSFET) for each battery.

6. The method of solution 1-4, wherein the electronic circuit comprises a network of 4 metal-oxide-semiconductor-field-effect-transistors (MOSFETs) which are connected as diodes for each battery.

7. The method of solution 1-4, wherein the electronic circuit comprises a network of 4 diodes for each battery.

8. The method of solution 1-7, wherein the batteries in use are of rechargeable types.

9. An electronic circuit, comprising: multiple transistors electronically coupled to multiple independent compartments of a battery pack, wherein each compartment of the multiple independent compartments is configured to allow insertion of at least one battery with any polarity orientation, and wherein the batteries inserted in the multiple compartments are without a directly electrical contact with each other, wherein the electronic circuit is configured to operate to provide a voltage to a load by coupling the multiple batteries according to a configuration; wherein the electronic circuit is integrated into a single integrated circuit (IC) package.

Two example circuits are disclosed in FIGS. 1A and 4 respectively. The first circuit (FIG. 1A) arrangement of the multiple transistors includes two N MOSFETS and two P MOSFETs (or equivalent). The second circuit arrangement (FIG. 4) shows four N MOSFETs (or equivalent) coupled to each other as described herein. It various embodiments, the above-described MOSFET transistors may be replaced with the other electrical circuits that exhibit a behavior similar to the MOSFETs, as described with respect to their on and off (or electrically closed and open) positions in response to the polarity and strength of the voltage applied across the positive node and the negative node.

10. The IC package of solution 9 is of a through-hole type for printed circuit board mounting.

11. The IC package of solution 9 is of a surface-mount type for printed circuit board mounting.

12. The IC package of solution 9 is made in one of a standard IC packages.

13. The IC package of solution 9 is made in a custom IC package.

14. The IC package of solution 9 including an over-current protection device and an over-temperature protection device.

15. The IC package of solution 9 including computer-controlled enabling and disabling circuits.

16. The IC package of solution 9 including a factory programmable control or field programmable control, wherein external connections, for the configuration, is configured internally in the IC, without need of an external connection.

17. The IC package of solution 9 including a factory configurable one-time fusible links or field configurable one-time fusible links, wherein all battery configurations are fabricated in the IC, and the final battery configuration is made, in the factory or in the field, by blowing or burning the appropriate fusible links.

18. The IC package of solution 9-17 including additional electronic circuits, each electronic circuit being configured for one configuration of battery connection.

19. The method of any of solutions 1-8, wherein the configuration connects the multiple batteries in series.

20. The method of any of solutions 1-8, wherein the configuration connects the multiple batteries in parallel.

21. The IC package of any of solutions 9-18, wherein the configuration connects the multiple batteries in a combined series/parallel configuration.

22. The IC package of any of solutions 9-18, wherein the configuration connects the multiple batteries in series.

23. The IC package of any of solutions 9-18, wherein the configuration connects the multiple batteries in parallel.

24. The method of any of solutions 1-8, wherein the configuration connects the multiple batteries in a combined series/parallel configuration.

In some embodiments, a method is provided by which an electronic circuit comprises transistors is configured to detect individual battery voltages of a battery pack of batteries in which multiple batteries are placed in an electrically isolated manner to provide a combined power from at least some of the multiple batteries to an external load. The detected individual battery voltages are used to identify a battery to be replaced and/or a battery that is bypassed by reorganizing an arrangement of the multiple batteries using the electronic circuit to provide a nominal voltage to the target.

In some embodiments, an electronic circuit, e.g., circuits described with reference to FIGS. 1 to 23, is disclosed. The electronic circuit includes an arrangement of at least four transistors. The electronic circuit is configured to detect a voltage output level of each of multiple battery cells in an arrangement of batteries in a battery pack. In case that the electronic circuit detects that an output voltage of a particular battery has fallen below a threshold, the electronic circuit reconfigures an ordering of the batteries in the battery pack such that a voltage level applied to a load of the battery pack is held at a constant nominal voltage. In some embodiments, during the reconfiguration, a switching glitch is avoided by operating a capacitor to provide the power during the reconfiguration. In some embodiments, the electronic circuit may provide an indication signal that identifies the battery whose voltage level has fallen below the threshold. For example, the indication signal may be in the form of lighting a light emitting diode affixed to the battery pack. The battery pack may include, for example, N LED lights in case that the battery pack is designed to hold N batteries (N a positive integer, typical values being 2 to 4). In one advantageous aspect, such embodiments will help with maximizing use of batteries to a level that is greater than a level at which batteries are conventionally discarded from use. In another advantageous aspect, such embodiments will help individually identify a specific battery to be replaced from a battery pack, rather than having to replace all batteries when the power level supplied by the battery pack drops below usable threshold.

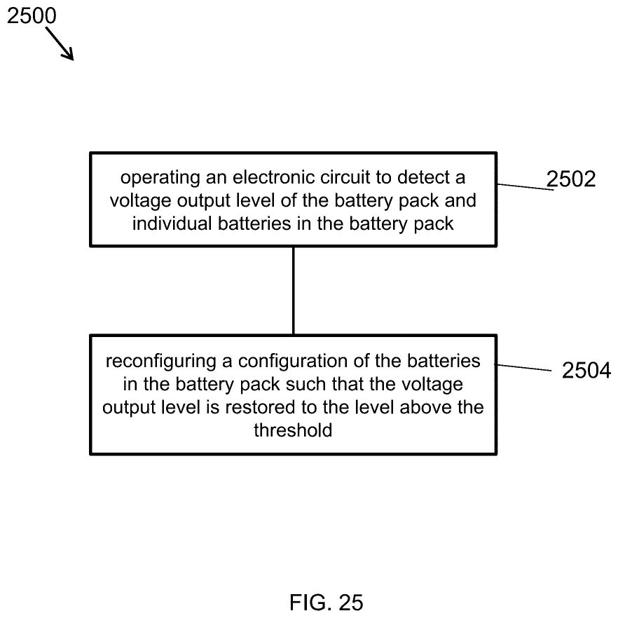

Accordingly, in some embodiments, a method (e.g., method 2500 depicted in FIG. 25) of extending useful life of batteries in a battery pack includes operating (2502) an electronic circuit to detect a voltage output level of the battery pack and individual batteries in the battery pack; and reconfiguring (2504), by the electronic circuit, upon detecting that the voltage output level of the battery pack has fallen below a threshold, a configuration of the batteries in the battery pack such that the voltage output level is restored to the level above the threshold.

Herein, the useful life may refer to use of a battery cell at a voltage level below what is typically used currently when users make a decision to discard the battery cell from use. The threshold used for reconfiguration may depend on the nature of load to which the battery is providing power. For example, certain electronic equipment such as lights may be more sensitive to battery voltage level than other electronic equipment (e. g., analog circuitry).

In some embodiments, the method includes operating a capacitor to provide power during a time that the reconfiguring is happening such that a switching glitch in the voltage output level is avoided. In general, there is a tradeoff between how size and capacity of the capacitor and the duration over which the capacitor will provide power to the load. For most consumer electronics use, a design target time of between 20 microseconds to 20 milliseconds may be used to avoid the switching glitch.

In some embodiments, the reconfiguring comprises altering a series/parallel configuration of the batteries. Some examples are disclosed in the present application for illustrative purpose but it will be appreciated that the configuration of series or parallel connections of N battery cells may include up to 2^{N} possibilities, over even more, depending on each cell being either a series cell or a parallel cell or may be electrically omitted out of the power supply configuration.

It will be appreciated by those of skill in the art that the present document discloses a technique that allows users to place batteries in a battery pack without having to worry about placement direction of the batteries such that an electronic circuit detects polarity orientation of each battery and operates to make an electrical connection to provide power to a load. It will further be appreciated that the present document discloses an electronic circuit that may be configured to receive a feedback signal from a load such that the electronic circuit operates to configure batteries in a battery pack to maximize useful life of each battery.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of connecting batteries in a battery pack, comprising:
providing a battery pack holder comprising multiple independent compartments, wherein each compartment is configured to hold at least one battery that has no direct electrical contact with batteries in other compartments of the multiple compartments;
automatically detecting, upon a placement of batteries in the multiple compartments, occurrence of the placement, and
operating an electronic circuit such that the batteries in the multiple compartments are connected together according to a configuration irrespective of polarity orientations of the placement of batteries.

2. The method of claim 1, wherein a load connected to the battery pack receives a same voltage and a same polarity irrespective of the compartmented battery polarity orientations.

3. The method of claim 1, wherein the electronic circuit comprises a network of 4 metal-oxide-semiconductor-field-effect-transistors (MOSFET) for each battery.

4. The method of claim 3, wherein, during the operating of the electronic circuit, a current output of the battery pack flows through a first MOSFET and a second MOSFET that are operating in a closed mode without flowing through a third MOSFET and a fourth MOSFET that are operating in an open mode.

5. The method of claim 1, wherein the electronic circuit comprises a network of 4 metal-oxide-semiconductor-field-effect-transistors (MOSFETs) which are connected as diodes for each battery.

6. The method of claim 1, wherein the electronic circuit comprises a network of 4 diodes for each battery.

7. The method of claim 1, wherein the configuration connects the multiple batteries in series.

8. The method of claim 1, wherein the configuration connects the multiple batteries in parallel.

9. The method of claim 1, wherein the configuration connects the multiple batteries in a combined series/parallel configuration.

10. The method of claim 1, wherein the operating the electronic circuit comprises operating the electronic circuit to open a first plurality of switches and closing a second plurality of switches to a load coupled to the battery pack.

11. An electronic circuit, comprising:
multiple transistors electronically coupled to multiple independent compartments of a battery pack,
wherein each compartment of the multiple independent compartments is configured to allow insertion of at least one battery with any polarity orientation, and
wherein the batteries inserted in the multiple compartments are without a direct electrical contact with each other, wherein the electronic circuit is configured to operate to provide a voltage to a load by coupling the multiple batteries according to a configuration;
wherein the electronic circuit is integrated into a single integrated circuit (IC) package.

12. The IC package of claim 11 is of a surface-mount type for printed circuit board mounting.

13. The IC package of claim 11 including an over-current protection device and an over-temperature protection device.

14. The IC package of claim 11 including computer-controlled enabling and disabling circuits.

15. The IC package of claim 11 including a factory programmable control or field programmable control, wherein external connections, for the configuration, is configured internally in the IC, without need of an external connection.

16. The IC package of claim 11 including a factory configurable one-time fusible links or field configurable one-time fusible links, wherein all battery configurations are fabricated in the IC, and a final battery configuration is made, in the factory or in the field, by blowing or burning appropriate fusible links.

17. The IC package of claim 11, wherein the configuration connects the multiple batteries in a combined series or parallel configuration.

18. A method of extending useful life of batteries in a battery pack, comprising:
operating an electronic circuit to detect a voltage output level of the battery pack and individual batteries in the battery pack; and
reconfiguring, by the electronic circuit, upon detecting that the voltage output level of the battery pack has fallen below a threshold, a configuration of the batteries in the battery pack such that the voltage output level is restored to the level above the threshold.

19. The method of claim 18, further including:
operating a capacitor to provide power during a time that the reconfiguring is happening such that a switching glitch in the voltage output level is avoided.

20. The method of claim 18, wherein the reconfiguring comprises altering a series/parallel configuration of the batteries.
